(19) United States
(12) Patent Application Publication
(10) Pub. No.: US 2013/0075338 A1
(43) Pub. Date: Mar. 28, 2013

(54) Induced-Gas Flotation Cell with Horizontal Flow

(71) Applicant: Terry C. Murtagh, Calgary (CA)

(72) Inventor: Terry C. Murtagh, Calgary (CA)

(21) Appl. No.: 13/240,398

(22) Filed: Sep. 22, 2011

(51) Int. Cl. C02F 1/24; C02F 1/40; B01D 17/035

(52) U.S. Cl. 210/703; 210/151

(57) ABSTRACT

An improved induced-gas separation vessel made according to this invention and method for its use includes an elongated, horizontally oriented vessel having compartments defined by adjacent pairs of perforated baffles which span the width but not the height of the vessel. One or more gas eductors are located within each compartment. An inlet device controls the momentum or velocity of the incoming water stream and rapidly converts it to horizontal flow prior to it encountering the first perforated baffle. The design of each baffle is such that the flow of water through each perforated baffle is a laminar or smooth flow without any change in direction. By controlling incoming velocity and providing perforated baffles, water distribution within the vessel is increased as is volumetric utilization. The total volumetric use of the vessel is at least 50% and can be as great as 80%.

### BACKGROUND OF THE INVENTION

This invention generally relates to apparatuses and methods for separating oil from a produced water stream. More specifically, this invention relates to apparatuses and methods which make use of induced-gas flotation cells for separating oil from a produced water stream.

Water produced in association with crude oil includes entrained contaminants such as residual oil and solids. Therefore, the water must be cleaned sufficiently of those contaminants prior to its disposal or injection. One of the more common cleaning methods involves introducing a natural gas flow through an eductor and into the produced water. The gas bubbles or droplets attach themselves to the oil, causing the oil to float to the surface of the water along with the gas. Controlling the gas droplet size and population can optimize oil removal efficiency. A detailed description of this method can be found in U.S. Pat. No. 7,157,007, titled “Vertical Gas Induced Flotation Cell” and issued to Frankiewicz et al. on Jan. 2, 2007, the subject matter of which is hereby incorporated by reference.

Prior art horizontal induced-gas floatation cells use a series of solid baffles and weirs to promote a downward and counter-current motion of the produced water and gas (see e.g. FIG. 6). Typically, two to four “cells” are used to obtain the desired water quality. This motion across multiple baffles does promote efficient removal of the entrained oil. However, several problems exist: (1) the movement of water over and under the baffles can create turbulence which disperses the oil into small droplets that cannot be removed; (2) counter-current flow of water and gas is not the most efficient separation method for the smallest oil droplets; and (3) the baffles cannot be optimized to prevent water channeling and achieve a high volumetric use, with volumetric use often being less than 50%.

### SUMMARY OF THE INVENTION

A system and method for removing entrained oil from a produced water stream makes use of an elongated, horizontally oriented separator vessel having a series of vertically oriented spaced-apart perforated baffles. The method includes the steps of:
introducing a flow of water into closed-elongated vessel;
flowing the flow of water through the perforated baffles in a horizontal flow; and
inducing a flow of gas into a lower portion of the vessel and between adjacent perforated baffles in the series of spaced-apart perforated baffles so that the flow of gas passes upward and through the horizontal flow of water.

The method preferably includes the step of reducing the incoming momentum or velocity of the flow of water as it enters the vessel and converting it rapidly to a horizontal flow prior to it encountering the first perforated baffle in the series of spaced-apart perforated baffles.

An improved induced-gas separation vessel made according to this invention includes compartments defined by adjacent pairs of perforated baffles which span the width but not the height of the vessel. One or more gas eductors are located within each compartment. An inlet device controls the momentum or velocity of the incoming water stream and rapidly converts it to horizontal flow prior to it encountering the first perforated baffle. The design of each baffle is such that the flow of water through each perforated baffle is a laminar or smooth flow without any change in direction. The total volumetric use of the vessel is at least 50% and can be as great as 80%.

### BRIEF DESCRIPTION OF THE DRAWINGS

FIG. 1 is a cross-section view of a preferred embodiment of an elongated separator vessel made according to this invention. The vessel includes a series of perforated baffles through which a produced water flow flows through. One or more eductors are arranged between each adjacent pair of baffles. The water flow through the baffles is a substantially unidirectional and horizontal, laminar (smooth) flow from one end of the vessel to the other.

FIG. 2 is a view taken along section line 2-2 of FIG. 1. Each baffle in the series of perforated baffles spans the width of the vessel but not the height and includes a plurality of spaced-apart perforations designed for laminar (plug) flow through the baffle.

FIG. 3 is a cross-section view of an alternate embodiment of an elongated separator vessel made according to this invention. This embodiment includes a fewer number of perforated baffles than the embodiment of FIG. 1. Similar to FIG. 1, an inlet device is used to control the momentum or velocity of the inlet water stream.

FIG. 4 illustrates the type of laminar or plug flow that occurs as the produced water flows from one end to the other of the separator vessel of FIGS. 1 and 3.

FIG. 5 illustrates the type of non-laminar or turbulent flow that a separator vessel made according to this invention avoids.

FIG. 6 is a prior art separator vessel that makes use of solid baffles to create a downward and counter-current motion of the produced water and gas as they flow through the vessel. Although this type of vessel is effective at removing entrained oil from the water, it can experience the problems discussed in the Background section above.

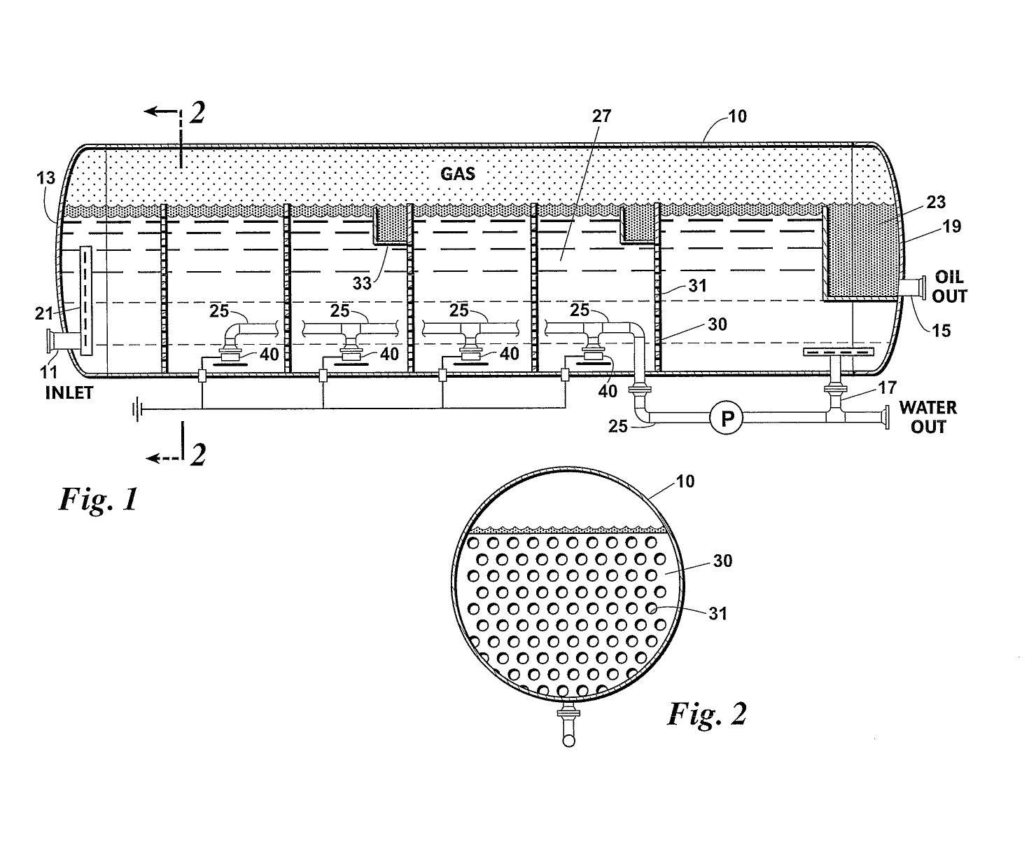

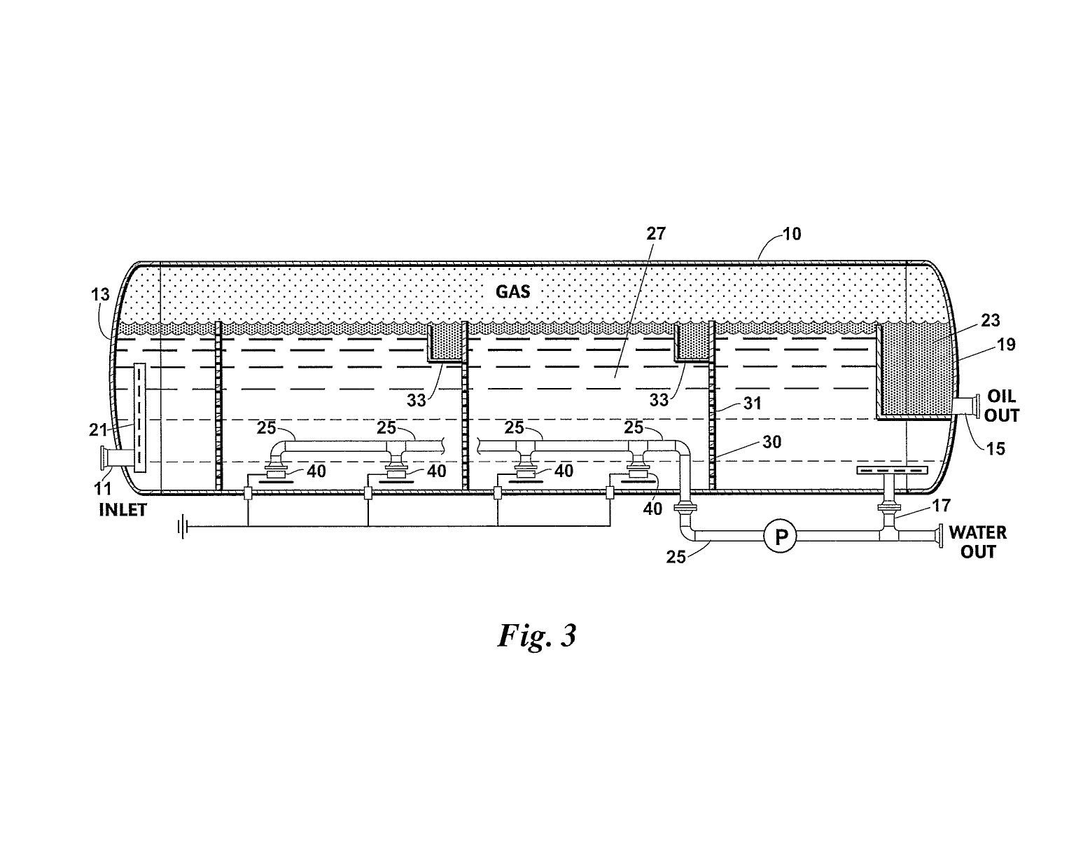

### ELEMENT NUMBERING USED IN THE DRAWINGS.

10 Separator vessel

11 Produced water inlet

13 First end

15 Oil outlet

17 Water outlet

19 Second end

21 Produced water inlet device

23 Oil box

25 Recycle loop

27 Compartment defined by adjacent baffles 30

30 Perforated plate or baffle

31 Perforations

33 Skimmer basket

40 Eductor

### DETAILED DESCRIPTION OF THE PREFERRED EMBODIMENTS

An induced-gas flotation cell made according to this invention includes an elongated, horizontally oriented separator vessel 10 of a kind used in the art and having a produced water inlet 11 at its first end 13 and an oil outlet 15 and a water outlet 17 located at its second end 19. Produced water inlet 11 is in communication with an inlet device 21 which functions to control the incoming momentum or velocity of the produced water stream entering the vessel 10 and create an initial, substantially horizontal flow of the incoming produced water stream. The produced water continues to flow from the first end 13 to the second end 19 in this same horizontal direction through a series of perforated baffles or plates 30. By controlling the momentum of the incoming produced water stream and converting it as rapidly as possible into smooth, horizontal flow, the damage done by the incoming stream to water droplets can be minimized and the volumetric utilization of vessel 10 can be maximized.

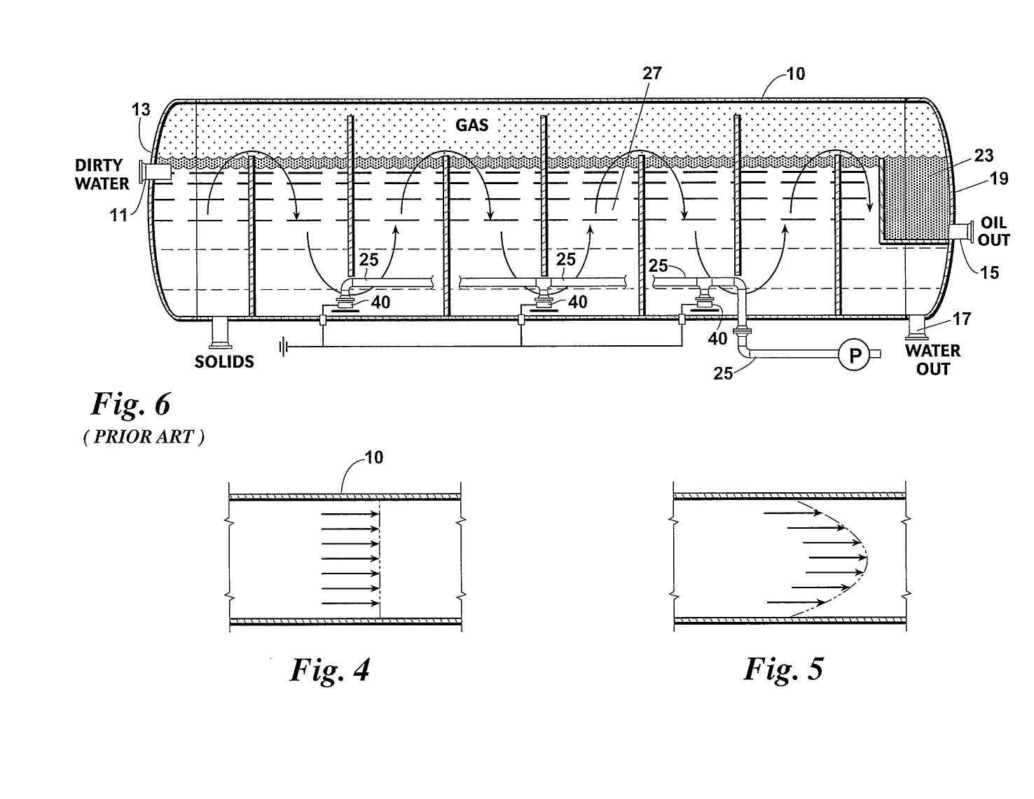

Each perforated baffle 30 spans the width but not the height of the vessel 10 and are spaced apart from one another so as to divide vessel 10 into several substantially equally sized compartments 27. The perforations 31 in each baffle 30 are sized so that the flow through the baffle 30 and compartment 27 is a laminar or smooth (“plug”) flow (see FIG. 4). In a preferred embodiment, perforations 31 were about 2 inches in diameter. Unlike prior art horizontal induced-gas flotation cells (see FIG. 6), the water flows from one compartment 27 to the next without a change in direction and substantially no turbulence. The design of perforated baffles 30 provides highly effective water distribution and significantly increases the volumetric utilization of vessel 10. In many cases, volumetric utilization can exceed 80%.

One or more eductors 40 of a kind known in the art are arranged in a lower portion 29 of vessel 10 and deliver gas bubbles or droplets which flow upward through the produced water. The gas droplets attach themselves to the oil entrained in the water, causing the oil to float to the surface of the water along with the gas. The foamy oil is removed using traditional oil removal techniques such an oil box 23. Skimmer buckets 33 may also be secured to an upper end of one or more of the perforated baffles 30. The substantially clean water exits the water outlet 17 where it may be further treated, disposed of, re-injected, or recycled back into vessel 10 by way of recycle loop 25.

While preferred embodiments of an induced-gas flotation cell made according to this invention have been described with a certain degree of particularity, the details of its construction and method of its use may be altered without departing from the literal or equivalent scope of the attached claims.

1. A method for removing entrained oil from a produced water stream, the method comprising the steps of:
introducing a flow of water into a vessel, the vessel being a closed-elongated vessel having a series of spaced-apart perforated baffles arranged perpendicular to a longitudinal axis of the vessel, each baffle having a plurality of circular perforations in a triangular pattern;
flowing the flow of water through the perforated baffles, the flow of water occurring substantially parallel to the longitudinal axis of the vessel;
inducing a flow of gas into a lower portion of the vessel and between adjacent perforated baffles in the series of spaced-apart perforated baffles, the flow of gas passing upward and through the flow of water.

2. A method according to claim 1 further comprising the introducing step including the sub-step of reducing a velocity of the flow of water as it enters the vessel and prior to a first perforated baffle in the series of spaced-apart perforated baffles.

3. A method according to claim 1 wherein a velocity of the flow of water through each perforated baffle is a laminar flow.

4. A method according to claim 1 wherein each perforated baffle spans a width of the vessel and not the height of the vessel.

5. A method according to claim 1 wherein the introducing step occurs in a lower half of the vessel.

6. A method according to claim 1 wherein a total volumetric use of the vessel is at least 50%.

7. A method according to claim 6 wherein the total volumetric use of the vessel is up to 80%.

8. An improved induced-gas separation vessel, the vessel being an elongated vessel having a produced water inlet at one end and an oil outlet and a treated water outlet at the other end, the vessel further including a plurality of gas eductors in its lower half for introducing a gas flow into the vessel; the improvement comprising:
a series of spaced-apart perforated baffles arranged perpendicular to a longitudinal axis of the vessel, each having a plurality of circular perforations in a triangular pattern and being arranged such that a flow of water passing through each perforated baffle maintains a constant direction of flow through the series of perforated baffles;
each eductor in the plurality of gas eductors being located between an adjacent pair of perforated baffles in the series of spaced-apart perforated baffles.

9. An improved induced-gas separation vessel according to claim 7 further comprising perforations in each perforated baffle being sized to allow a laminar flow.

10. An improved induced-gas separation vessel according to claim 8 further comprising each perforated baffle spanning a width of the vessel and not the height of the vessel.

11. An improved induced-gas separation vessel according to claim 8 further comprising an inlet device located within the vessel between the produced water inlet and a first perforated baffle in the series of spaced-apart perforated baffles and in communication with the produced water inlet, a produced water entering the inlet device having a different momentum than produced water exiting the inlet device.

12. An improved induced-gas separation cell according to claim 11 wherein the produced water exiting the inlet device exits in a substantially horizontal flow direction.

13. A system for removing entrained oil from a produced water stream, the system comprising:
a closed-elongated vessel having a height, width, and longitudinal axis, the vessel receiving a flow of water;
a series of spaced-apart perforated baffles within the vessel, the baffles having a plurality of circular perforations in a triangular pattern and being arranged perpendicular to the vessel's longitudinal axis, through which the flow of water flows in a direction that is substantially parallel to the vessel's longitudinal axis; and
a series of eductors that induce a flow of gas into a lower portion of the vessel and between adjacent baffles in the series of spaced-apart perforated baffles such that the flow of gas passes upward and through the flow of water.

14. A system according to claim 13 wherein perforations in each baffle are sized to allow the flow of water to be a laminar flow.

15. A system according to claim 13 wherein each baffle spans the width of the vessel and not the height of the vessel.

16. A system according to claim 13 wherein the vessel receives the flow of water through a produced water inlet which is located in the lower portion of the vessel.

17. A system according to claim 13 wherein a total volumetric use of the vessel is at least 50 percent.

18. A system according to claim 17 wherein the total volumetric use of the vessel is no greater than 80 percent.

19. A system according to claim 13 further comprising an inlet device located within the vessel between the produced water inlet and a first baffle in the series of spaced-apart perforated baffles and in communication with the produced water inlet, a flow of water entering the inlet device having a different velocity than the flow of water exiting the inlet device.

20. A system according to claim 19 wherein the direction of the flow of water exiting the inlet device is substantially horizontal.
